(19) United States
(12) Patent Application Publication
(10) Pub. No.: US 2005/0136824 A1
(43) Pub. Date: Jun. 23, 2005

(54) Air-passage opening/closing device

(76) Inventors: Yoshihiko Okumura, Kariya-city (JP); Koji Ito, Nagoya-city (JP); Eiichi Hasada, Okazaki-city (JP); Yasuhiro Sekito, Kariya-city (JP)

Correspondence Address: HARNESS, DICKEY & PIERCE, P.L.C., P.O. BOX 828, BLOOMFIELD HILLS, MI, 48303, US

(21) Appl. No.: 11/013,100

(22) Filed: Dec. 15, 2004

(30) Foreign Application Priority Data
Dec. 19, 2003 (JP) 2003-422902
Jun. 29, 2004 (JP) 2004-190796

(51) Int. Cl. B60H 3/00

(52) U.S. Cl. 454/156

(57) ABSTRACT

An air passage flow control device according to the invention includes a plate member having at least one aperture through which air may pass, the degree to which the aperture is exposed being controlled by the positioning of a film member across at least a portion of the aperture. The positioning of the film member relative to the aperture is controlled by rolling and unrolling a portion of the film member on a rotating member that may be selectively moved back and forth across the aperture. By rolling and unrolling the film member to control the opening of the aperture, the present invention avoids relative lateral movement of those portions of the film member that are in contact with the plate member, thereby reducing the frictional forces. Further, the rotating member is configured to reduce the collection of particulate matter on the rotating member and the film member.

### PRIORITY STATEMENT

This U.S. nonprovisional application claims priority on Japanese Patent Application No. 2003-422902 filed on Dec. 19, 2003, and No. 2004-190796 filed on Jun. 29, 2004, the disclosures of which are incorporated herein by reference in their entirety.

### FIELD OF THE INVENTION

The present invention generally relates to an air-passage opening/closing device suitable for use in a variety of air handling or conditioning devices including, for example, automotive air conditioning systems.

### BACKGROUND OF THE INVENTION

Conventional air-passage opening/closing devices may include a case and a plate member disposed within the case. The plate member may include one or more apertures through which air or other fluid may pass with a film member disposed adjacent the plate member and configurable for at least partially obstructing the aperture(s). The film member may also include at least one opening through which air may pass, and both ends of the film member may be connected to rotating shafts in a manner whereby rotation of one or more of the shafts will alter the configuration of the film member relative to the plate member and the aperture(s) provided therein.

In this manner, one or more openings provided in the film member may be selectively moved from side-to-side, thereby altering the alignment of the respective opening(s) and aperture(s) to control the flow of air or other fluid through the plate member. However, as embodied in a conventional mechanism, the film member will typically be moved in a plane generally parallel to the plate member, thereby causing portions of the film member to slide along one or more surfaces adjacent the aperture(s).

This movement of the film member relative to the plate member results in frictional forces generated between the contacting portions of the film member and the plate member that must be overcome in order to reposition the film member. Furthermore, because the film member will typically be arranged upstream from the plate member whereby the air pressure will tend to force portions of the film member against the plate member, the frictional forces associated with moving the film member and wear on the film member may be further increased. As used herein, the terms upstream and downstream correspond to the normal direction of flow through the aperture. As a result, a special material or combination of materials will typically be utilized in the construction of the film member to provide a combination of properties including low friction, large tensile strength and large tear strength to produce a sufficiently durable and configurable film member.

### BRIEF SUMMARY OF THE INVENTION

Exemplary embodiments of the present invention may be utilized for reducing the frictional forces generated between the film member and the plate member during reconfiguration of the film member.

Exemplary embodiments of the present invention may also be utilized to reduce the likelihood that particulate contamination, such as dust, pollen or sand, will accumulate on the film member or the rotating member or be trapped between adjacent layers of the film member as it is rolled onto the rotating member.

In an exemplary utilization of an embodiment of the present invention, one or more air passage controlling devices according to the present invention may be incorporated into an automotive air conditioning unit for controlling the flow of ambient, heated and/or cooled air through the unit.

### BRIEF DESCRIPTION OF THE DRAWINGS

The present invention will be more readily apparent from the following detailed description of example embodiments when taken together with the accompanying drawings, in which:

FIG. 1 illustrates a cross section of an air-conditioning unit according to an exemplary embodiment of the present invention;

FIG. 2 illustrates a cross section of the exemplary embodiment of the invention illustrated in FIG. 1 taken along line C-C′; and

FIG. 3 illustrates an exemplary embodiment of an opening and closing device according to the present invention suitable for utilization in the air-conditioning unit shown in FIG. 1.

In the drawings, it should be understood that the thicknesses and relative positioning and sizing of the illustrated components, elements and mechanisms are not necessarily drawn to scale and may have been enlarged, reduced, simplified or otherwise modified for improved clarity. Also, throughout the drawings, similar or identical reference numerals are used to refer to similar, corresponding or identical elements.

### DESCRIPTION OF THE EXEMPLARY EMBODIMENTS

The present invention now will be described more fully with reference to the accompanying drawings, in which exemplary embodiments of the present invention are shown.

As those of ordinary skill in the art will appreciate, however, the invention may be embodied in many different forms and should not be construed as limited to the specific embodiments described herein. It will also be appreciated that these exemplary embodiments are provided so that this disclosure will be thorough and complete, and will fully convey the scope of the invention to those skilled in the art.

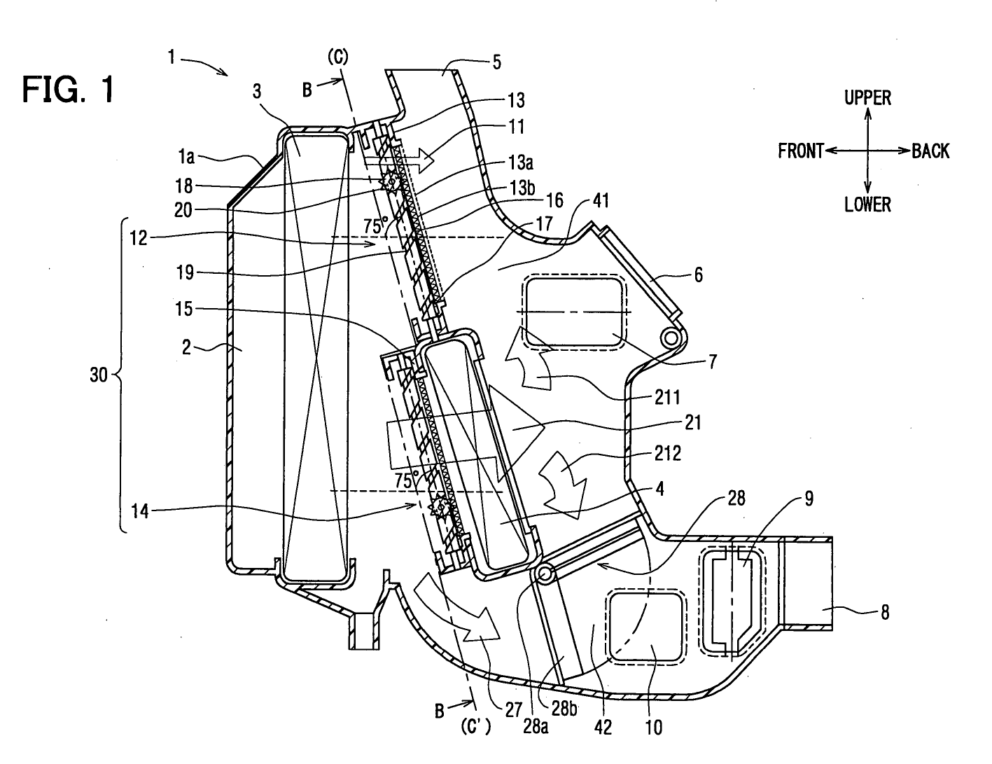

A ventilation system of an air-conditioner for a vehicle may include an air-conditioning unit 1 as shown in FIG. 1 and a blower unit (not shown) for forcing air into and/or through the air-conditioning unit. The air-conditioning unit 1 may be disposed in a generally central position along a width direction (right and left direction) of a vehicle and may, for example, be positioned totally or partially within an instrument panel provided across a forward portion of the passenger compartment of the vehicle.

As illustrated in FIG. 1, the orientation of the air-conditioning unit 1 relative to the remainder of the vehicle may be as indicated by the directional arrows provided in the upper right portion of FIG. 1. As indicated by the directional arrows the x-axis designates the front and rear portions of the vehicle and the y-axis designates the upper and lower portions of the vehicle.

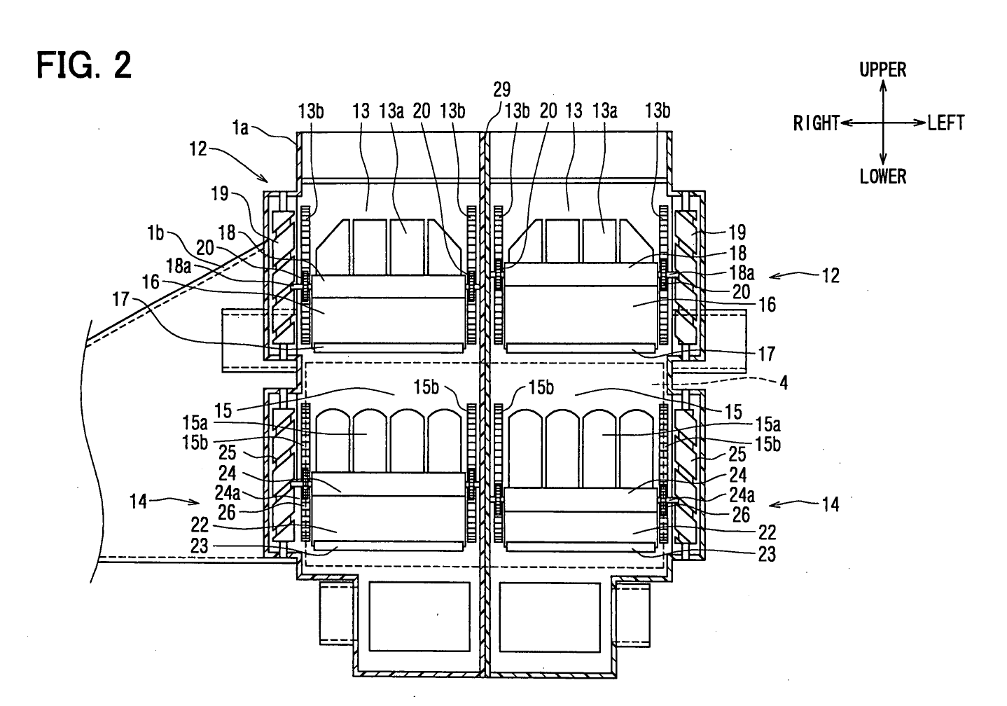

It will also be appreciated that in the illustrated orientation that a z-axis (not shown) normal to the illustrated x and y axes would designate the left (the portion extending outwardly) and right (the portion extending inwardly) portions of the vehicle. Similarly, FIG. 2 illustrates a cross-sectional view of the air conditioning unit 1 of FIG. 1 taken along line C-C′ and rotated 90° about the y-axis. Accordingly, in FIG. 2 the x-axis (not shown) extending into the page would designate the rear portion of the vehicle and the x-axis extending outwardly from the page would designate the front portion of the vehicle. To the extent that directional modifiers are utilized in the following discussion of the invention, they should be understood as generally corresponding to the orientation illustrated in FIGS. 1 and 2.

One or more blower unit(s) (not shown), operatively connected to the air conditioning unit 1 for selectively generating air-flow through the unit, may be also disposed inside the instrument panel. The blow unit(s) (not shown) and may be shifted relative to the air-conditioning unit 1 in a direction along the vehicle's width, typically toward a front passenger seat side. Although the blower unit(s) may be shifted to either side of the air-conditioning unit 1, as illustrated in this exemplary embodiment the blower unit(s) are shifted to the right side of the air-conditioning unit 1.

The air conditioning unit 1 may include an air-conditioning case 1a that forms one or more air paths through the unit. The air-conditioning case 1a may be made of a polymeric resin material and may include internal dividers for separating portions of the case and air path(s). As illustrated in FIG. 2, the air-conditioning case 1a may be divided into left side case portion and right side case portion along a vertical plane through a generally central portion of the case. The two case portions may be integrally connected to each other by using one or more suitable fastening means such as metal spring clips, bolts, screws and/or latches.

An air inlet 2 may be provided through a front portion of the air-conditioning case 1a whereby air exiting the blower unit will tend to flow into the case and through the air path(s) defined therein.

An evaporator 3 may be positioned within an air passage provided in the air-conditioning case 1a, and a heater 4 may be similarly positioned downstream of the evaporator within the same or a cooperating air passage that may receive air that has been previously exposed to the evaporator 3. The evaporator 3 may be a low-pressure side heat exchanger of a vapor compression refrigeration cycle, and may act as a cooling heat exchanger for cooling air passing therethrough. The heater 4 may derive heat from waste heat generated in a vehicle engine or the like, and may act as a heating heat exchanger for heating air passing therethrough.

As illustrated in FIG. 1, the air-conditioning unit 1 may include a upper bypass path 11 above the heater 4 and a lower bypass path 27 below the heater 4. Those two bypass paths 11, 27 may act singly or in combination to form an air passage that will allow air flow to bypass the heater 4.

The air-conditioning unit 1 may also include a hot-air path 21 arranged between the two bypass paths 11 and 27 with the heater 4 disposed in the hot-air path 21. The hot-air path 21 may separate into a upward hot-air path 211 and a downward hot-air path 212 at a point downstream from the heater 4.

The air-conditioning unit 1 may include a front-side air-mixing device 30. The front-side air-mixing device 30 may include a front-side cool-air adjusting device 12 (described hereinafter) and a front-side hot-air adjusting device 14 (described hereinafter). The front-side air-mixing device 30 may be used adjust an air-flow ratio between the amount of air passing through the upper bypass path 11 and the amount of air passing through the hot-air path 21. Accordingly, the front-side air-mixing device 30 may control the amount of air bypassing the heater 4 through the upper bypass path 11 and may control the amount of air flowing through the heater 4.

The air-conditioning unit 1 may further include a rear-side air-mixing device 28. The rear-side air-mixing device 28 may include a rotational shaft 28a rotatably supported with the air-conditioning case 1a, and may include a flat plate door portion 28b connected to the rotational shaft 28a. The rear-side air-mixing device 28 may adjust an air-flow ratio between the volume of air passing through the lower bypass path 27 and the volume of air passing through the hot-air path 21. Accordingly, the rear-side air-mixing device 28 may control an amount of air bypassing the heater 4 through the lower bypass path 27 and may control the amount of air flowing through the heater 4.

The air-conditioning unit 1 may include a front-side air-mixing chamber 41 in which cool air flowing through the upper bypass path 11 and hot air flowing through the front-side hot-air path 211 are mixed. Also, the air-conditioning unit 1 may include a rear-side air-mixing chamber 42 in which cool air flowing through the lower bypass path 27 and hot air flowing through the rear-side hot-air path 212 are mixed.

The air-conditioning case 1a may include plural front-side air openings 5-7 arranged downstream from both the evaporator 3 and the heater 4. Air flowing through the upper bypass path 11 and/or air through the front-side hot-air path 211 will typically be discharged into the front portion of the vehicle's passenger compartment through at least one of the front-side air openings 5-7 according to the users' configuration of the associated control means.

A defroster air opening 5 may be disposed in an upper wall of the air-conditioning case 1a and may be connected to a defroster air duct (not shown). The defroster air duct may include a defroster air outlet at one end thereof, and air discharged from the defroster air outlet may be blown toward an inner surface of a front windshield.

A front-side face air opening 6 may be disposed at an upper side of a back wall of the air-conditioning case 1a closer to a back of the vehicle than the defroster air opening 5. The front-side face air opening 6 may be connected to a front-side face air duct (not shown). The front-side face air duct may include a front-side face air outlet at one end thereof, and air discharged from the front-side face air outlet may be blown toward an upper body of the front passenger(s).

A front-side foot air opening 7 may be disposed at both the right and left side walls of the air conditioning case 1a closer to a front of the vehicle than the front-side face air opening 6. Each of the front-side foot air openings 7 may be connected to a respective front-side foot air duct (not shown). Each of the right and left front-side foot air ducts may include a front-side foot air outlet at one end thereof, and air discharged from the front-side foot air outlets may be blown toward the knees of the front passenger(s).

The air-conditioning case 1a may also include plural rear-side air openings 8-9 arranged downstream from the evaporator 3 and the heater 4. Air passing through the lower bypass path 27 and/or air through the rear-side hot-air path 212 may be discharged toward a rear side of a passenger compartment through at least one of the rear-side air openings 8-9.

A rear-side face air opening 8 may be disposed at a lower side of a back wall of the air-conditioning case 1a. The rear-side face air opening 8 may be connected to a rear-side face air duct (not shown). The rear-side face air duct may include a rear-side face air outlet at one end thereof, and air discharged from the rear-side face air outlet may be blown toward the upper body of any rear seat passenger(s).

A rear-side foot air opening 9 may be disposed at both the right and left side walls of the air conditioning case 1a closer to a front of the vehicle than the rear-side face air opening 8. Each of the rear-side foot air openings 9 may be connected to a respective rear-side foot air duct (not shown). Each of the right and left rear-side foot air ducts may include a rear-side foot air outlet at one end thereof, and air discharged from the rear-side foot air outlets may be blown toward the knees of the rear passenger(s).

A middle-side air opening 10 may be provided in both the right and left side walls of the air conditioning case 1a closer to a front of the vehicle than the rear-side foot air openings 9. Each of the middle-side air openings 10 may be connected to a respective middle-side air duct (not shown). Each of the right and left middle-side air ducts may be disposed in a B-pillar. Also, each of the right and left middle-side air duct may include a middle-side air outlet at one end thereof, and air discharged from the middle-side air outlets may be blown toward the passenger compartment of the vehicle. Each of the openings 5-10 discussed above may be opened or closed independently by outlet mode switching doors (not shown).

The air-conditioning case 1a may include a front-side cool-air plate member 13 above the heater 4. One or more front-side cool-air aperture(s) 13a, which may form a part of the front-side bypass path 11, may be provided through the front-side cool-air plate member 13. The front-side cool-air plate member 13 will typically have a substantially planar peripheral surface surrounding the aperture(s) and may be oriented in a substantially vertical direction or may be inclined from vertical with an upper portion being located upstream relative to a lower portion. For example, as illustrated in FIG. 1, the inclination angle of the front-side cool-air plate member 13 with respect to a horizontal line may be about 75° (corresponding to an inclination angle of about 15° with respect to a vertical line). Further, the peripheral surface(s) may be constructed with non-planar configuration such as a shallow arcuate curve.

The air-conditioning case 1a may also include a hot-air plate member 15 arranged downstream from the heater 4. One or more hot-air apertures 15a, which may form a part of the hot-air path 21, may be provided through the hot-air plate member 15. The hot-air plate member 15 may have a relatively planar peripheral surface surround the aperture(s) and may be inclined from vertical in a manner such that an upper portion thereof may be located upstream compared to a lower portion thereof. For example, as illustrated in FIG. 1, the hot-air plate member 15 is positioned with respect to a horizontal line at an inclination angle of about 75°.

A partition wall 29 (shown in FIG. 2) may be disposed downstream from the evaporator 3 in a central portion of the air-conditioning case 1a. The partition wall 29 may separate an air path in the air-conditioning case 1a into a left air path and a right air path in such a manner that air passing through the left air path may be discharged toward a front-left-side portion of the passenger compartment while air passing through the right air path may be discharged toward a front-right-side portion of the passenger compartment. In this example embodiment, the front-side air-mixing device 30 may be separated into a right-front-side air-mixing device 30 and a left-front-side air-mixing device 30.

In this exemplary embodiment, an air-conditioning controlling device (ECU, not shown) may be supplied with a signal from an internal air temperature sensor (not shown) for detecting air temperature in the passenger compartment of the vehicle, a signal from an outside air temperature sensor (not shown) for detecting the air temperature of the ambient air surrounding the passenger compartment, a signal from a sunlight sensor (not shown) for detecting a sunlight amount radiated into the passenger compartment, a signal from a right-side temperature setting device (not shown) for setting the target temperature in the right side of the compartment by an occupant, a signal from a left-side temperature setting device (not shown) for setting the target temperature in the left side of the passenger compartment by an occupant, and a signal from a rear-side temperature setting device (not shown) for setting the target temperature in the rear side of the passenger compartment by an occupant.

The ECU may calculate a right-side target blowout temperature (TAO(R)), a left-side target blowout temperature (TAO(L)) and a rear-side target blowout temperature (TAO(rear)), each based on the signals described above. The ECU may calculate the respective target blowout temperatures (TAO(R), TAO(L), TAO(rear)) in accordance, for example, with a computer program stored therein, for example, in a ROM (read-only memory) or the like.

The ECU may control the blower unit based on the target blowout temperatures (TAO(R), TAO(L), TAO(rear)), and as a result, air amount toward the compartment of the vehicle may be controlled.

The ECU may also control the right-front-side air-mixing device 30 based on the right-side target blowout temperature (TAO(R)) and may control the left-front-side air-mixing device 30 based on the left-side target blowout temperature (TAO(L)). As a result, each of air temperature toward the front-right-side of the passenger compartment and air temperature toward the front-left-side of the passenger compartment may be controlled independently. The ECU 30 may further control the rear-side air-mixing device 28 based on the rear-side target blowout temperature (TAO(rear)), and as a result, air temperature toward the rear-side of the passenger compartment may be controlled.

The ECU 30 may still further control the outlet mode switching doors based on the target blowout temperatures (TAO(R), TAO(L), TAO(rear)), and as a result, front-side air outlet modes and rear-side air outlet modes may be controlled. The front-side air outlet modes may include a front-side face mode in which the doors may open the front-side face air opening 6 and may close both the defroster air opening 5 and the front-side foot air opening 7, a front-side bi-level mode in which the doors may open both the front-side face air opening 6 and the front-side foot air opening 7 and may close the defroster air opening 5, a front-side foot mode in which the doors may open the front-side foot air opening 7 and may close both the defroster air opening 5 and the front-side face air opening 6, and a defroster mode in which the doors may open the defroster air opening 5 and may close the other openings 6-10.

Also, the rear-side air outlet modes may include a rear-side face mode in which the doors may open the rear-side face air opening 8 and may close the rear-side foot air opening 9, a rear-side bi-level mode in which the doors may open both the rear-side face air opening 8 and the rear-side foot air opening 9, and a rear-side foot mode in which the doors may open the rear-side foot air opening 9 and may close the rear-side face air opening 8.

In this example embodiment, the structure of the right-front-side air-mixing device 30 and the structure of the left-front-side air-mixing device 30 may be symmetry with each other. Therefore, a detail structure of the right-front-side air-mixing device 30 will be now described, and a detail structure of the left-front-side air-mixing device 30 will be omitted.

First, a detailed structure of the exemplary upper and lower air flow control devices 12, 14 will be now described with reference to FIGS. 1, 2 and 3. As illustrated, the exemplary air flow control device 12, 14 may include a pair of linear gears 13b, 15b a film member 16, 22 a fixing member 17, 23 a rotating shaft 18, 24 a pair of small diameter portions 18a, 24a a pair of circular gears 20, 26 a cylinder shaft 19, 25 and an electric motor (not shown) connected to the cylinder shaft 19, 25.

The linear gears 13b, 15b may be disposed along the sides of the plate member 13, 15 and separated from the edges of the apertures 13a, 15a. Each of the linear gears 13b, 15b may extend in a generally parallel manner along opposite sides of the plate member. In the illustrated embodiment, the linear gears 13b, 15b will typically be arranged in a generally vertical orientation.

The film member 16, 22 may be formed from a flexible resin film (e.g., PET and/or PPS) having sufficient strength to seal the aperture. As illustrated, the lower end of the film member 16, 22 may be fixed to the plate member 13, 15 at a point below the aperture 13a, 15a by using a fixing member 17, 23, an adhesive or other suitable fastening means for securing the film member. The opposite and upper end of the film member 17, 23 will be fixed to the rotational shaft 18, 24.

The rotating shaft 18, 24 will typically be disposed upstream from the plate member 13, 15 and may include the small diameter portions 18a, 24a at one or both ends. Each of the small diameter potions 18a, 24a may include a circular gear 20, 26 which is configured to engage the corresponding linear gear 13b, 15b.

The cylinder shaft 19, 25 may be configured in a substantially parallel relationship with the linear gears 13b, 15b and may include a spiral groove 19a, 25a on the surface thereof. The cylinder shaft 19, 25 may also include pins 19b, 25b at both sides thereof. Both pins 19b, 25b may be rotatably supported with the air-conditioning case 1a, and one of the pins 19b, 25b may be connected to an electric motor (not shown) or other operative mechanism arranged outside the air-conditioning case 1a. One of the small diameter potions 18a, 24a may be sized and configured for insertion into the corresponding spiral groove 19a, 25a.

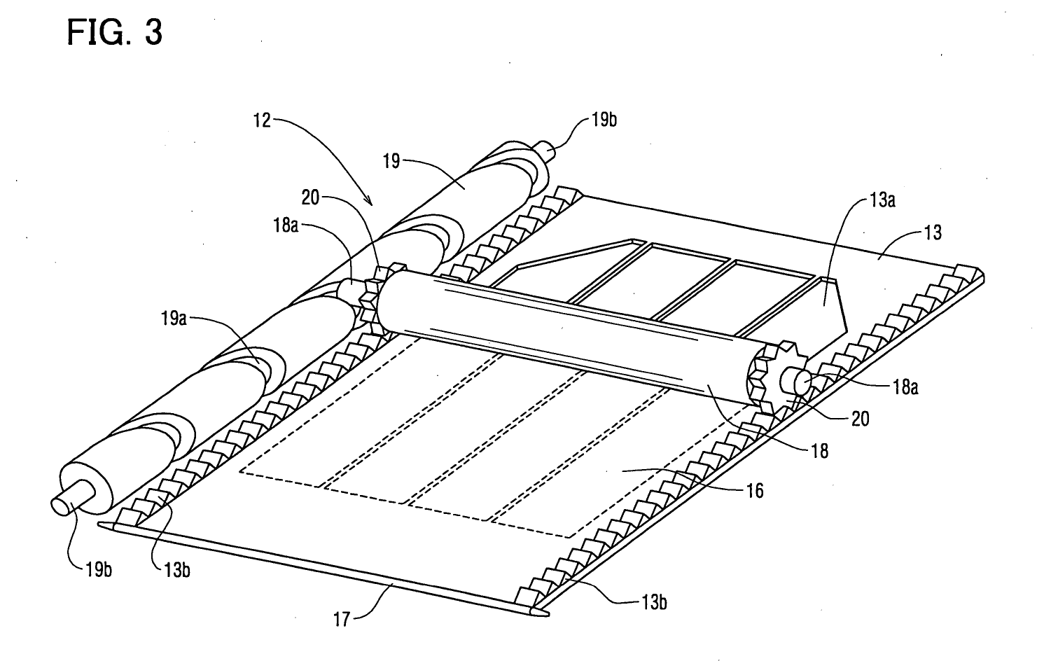

In the exemplary embodiment as illustrated in FIGS. 1 and 3, when the electric motor or other operative mechanism is engaged to rotate the cylinder shaft 19 in a counterclockwise direction, the spiral groove 19a will tend to move the small diameter portion 18a away from the fixed end of the film member 16 resulting in a corresponding rotation and movement of the rotating shaft 18 in a direction generally parallel to the plate member 13. This rotation of the rotating shaft 18 will cause a portion of the film member 16 to unroll from the rotating shaft and cover an additional portion of the aperture 13a. The unrolled portion of the film member 16 will typically be supported on at least the surfaces of the plate member 13 that surround the aperture(s) and, when provided upstream from the plate member, will be pressed against the plate member by the pressure differential produced by the air flowing through the passage.

Conversely, when the electric motor (not shown) or other operating mechanism is engaged to rotate the cylinder shaft 19 in a clockwise direction, the spiral groove 19a will tend to force the small diameter portion 18a toward the fixed end of the film member 16. This will, in turn, result in movement and counterclockwise rotation of the rotating shaft 18 in a direction generally parallel to the plate member 13. This rotation of the rotating shaft 18 will tend to roll a portion of the film member 16 onto the rotating shaft, thereby exposing an additional portion of the aperture 13a.

The rotating shaft 18 and the circular gear 20 may be disposed separately from each other, with the rotating shaft and the circular gear connected through a flexible member (not shown) in such a manner that the flexible member may force the rotating shaft to roll and unroll the film member 16.

As detailed in the discussion of the exemplary embodiment provided above, the rotating member may be disposed in a generally horizontal configuration and attached to the film member in a manner whereby the film member is unrolled as the rotating member moves in a generally upward direction. By configuring these elements in this manner no lower “pocket” or “shelf” region is formed that would tend to accumulate particulate matter present in the air flowing through the air passage. Similarly, inclining the flow control member in a manner that the upper portion is in an upstream configuration relative to the lower portion will tend to utilize gravity and flow effects to prevent or reduce the air flowing through the air passage from forcing particulate matter up along the film member and into the gap formed between the upper unrolled portion of the film member and the adjacent rotating member and/or a portion of the film member rolled onto the rotating member.

It will also be appreciated that some of the advantages provided by the particular configuration discussed above can also be obtained by essentially rotating the flow control device assembly as described above 90° so that the rotating member will be in a generally vertical orientation. This configuration will also tend to reduce or eliminate the excessive collection of particulate matter on the film member and the rotating member. As with the previously described embodiment, this alternative embodiment may also be inclined so that an upper portion of the rotating member is in an upstream position relative to a lower portion. By configuring these structural elements in this manner, gravity may be utilized to prevent excessive accumulation of particulate matter on the film member and/or rotating member and improve the performance of the flow control device.

As illustrated in FIG. 2, the exemplary embodiment includes four separate air flow control devices, each of which may have generally similar construction for convenience of manufacture. Those of ordinary skill will, however, appreciate that each of the flow control devices may be sized and configured differently to adjust their relative performance by, for example, providing for different maximum flow rates through the various air paths, providing one or more film members with openings to maintain a certain minimum air flow and/or the lower fixed end of one or more of the film members offset to expose a lower portion of the corresponding aperture. Similarly, different materials, additives and/or coatings could be utilized in the film members to provide, for example, increased durability, antistatic properties, resistance to bacterial and fungal growth, improved low temperature flexibility and/or better high temperature performance. Further, the geared portions of the air flow control devices may be modified to provide faster movement and/or finer positioning of the film member relative to the plate member.

Further according to this exemplary embodiment, the plate member 13, 15 may be inclined in such a manner that an upper portion will be located upstream relative to a lower portion. Concurrently, the corresponding film member 16, 22 may be inclined in such a manner that an upper portion will be located upstream relative to a lower portion thereof. By utilizing this configuration, the pressure exerted on the film member 16, 22 by the air flow will tend to force the film member against the corresponding plate member 13, 15 and improve the sealing effect. Further, foreign matter such as particulate contamination entering the air conditioning housing 1a from the blower (not shown) or another source will not tend to accumulate excessively on the film member 16, 22.

According to the exemplary embodiment described above, although the film members 16, 22 may be inclined so that their upper portion is located upstream relative to their lower portion, the film members 16, 22 may also be disposed in a substantially vertical orientation or inclined with their upper portion located downstream relative to their lower portion. In any event, however, it is preferable that the orientation of the film members 16, 22 is such that accumulation of particulate matter from the air stream on the film members is reduced or sufficiently controlled.

Although, as illustrated in FIG. 1 the exemplary embodiment utilizes an inclination angle of the plate members 13, 15 with respect to a horizontal line of about 750, other inclination angles of as little as 60° may prove suitable. In general, however, it is preferred that the inclination angle be between about 65 and 85° and even more preferred that the inclination angle be between about 70 and 80°.

According to the exemplary embodiment described above, the plate members 13, 15 preferably have a substantially flat shape with the corresponding film members 16, 22 being disposed upstream from the plate members. Those of ordinary skill will appreciate, however, that the plate members 13, 15 may utilize non-planar configurations including simple or complex curved surfaces with the corresponding film members 16, 22 and other structures adapted accordingly. Similarly, the film member(s) may be disposed downstream of the corresponding plate member(s) if satisfactory air flow control can be maintained.

Although the invention has been described with reference to certain exemplary embodiments and preferred configurations, those of ordinary skill will appreciate that the invention may be expressed in other embodiments consistent with the disclosure and examples provided above.

1. An air passage flow control device comprising:
a plate member including an aperture arranged across an air passage;
a film member disposed adjacent the plate member, the film member being configurable for selectively covering or uncovering at least an upper portion of the aperture; and
a rotating member disposed adjacent the plate member and configured for movement between first and second positions along the plate member, whereby a portion of the film member is rolled onto the rotating member during movement in a first direction and unrolled from the rotating member during movement in a second and opposite direction, the rotating member being located substantially below any portion of the aperture uncovered by rolling the film member onto the rotating member.

2. An air passage flow control device according to claim 1, wherein:
the film member is positioned upstream relative to the plate member.

3. An air passage flow control device according to claim 1, further comprising:
a positioning mechanism for selectively moving the rotating member to any position between the first and second positions.

4. An air passage flow control device according to claim 1, wherein:
the rotating member has a major longitudinal axis, the longitudinal axis being arranged in a generally horizontal orientation and further wherein, the generally horizontal orientation is maintained as the rotating member moves between the first and second positions.

5. An air passage flow control device according to claim 3, wherein:
the positioning mechanism includes a rotating shaft, the rotating shaft including a spiral groove, the spiral groove configured for receiving a following member, the following member being attached to the rotating member whereby rotation of the rotating shaft will alter the position of the rotating member in the first or second direction.

6. An air passage flow control device according to claim 5, further comprising:
first and second rack segments arranged on opposite sides of the aperture and aligned with the first and second directions; and
first and second gears attached to the rotating member, the first and second gears cooperating with the first and second rack segments to maintain the aligned orientation of the rotating member during movement in the first and second directions.

7. An air passage flow control device according to claim 1, wherein:
the plate member is inclined from a vertical orientation by an inclination angle of no more than about 30°.

8. An air passage flow control device according to claim 7, wherein:
the plate member is inclined in a manner whereby an upper portion is arranged upstream relative to a lower portion.

9. An air passage flow control device according to claim 8, wherein:
the plate member is inclined at an inclination angle between about 5 and about 20° from vertical.

10. An air passage flow control device according to claim 1, further comprising:
an attachment member for securing a fixed end of the film member, the fixed end being arranged below the rotating member.

11. An air passage flow control device comprising:
a plate member including an aperture arranged across an air passage;
a film member disposed adjacent the plate member, the film member being configurable for selectively covering or uncovering at least a portion of the aperture; and
a rotating member disposed adjacent the plate member and configured for movement between first and second positions along the plate member, whereby a portion of the film member is rolled onto the rotating member during movement in a first direction and unrolled from the rotating member during movement in a second direction, the first and second directions being substantially opposite, the rotating member being offset in a horizontal direction from any portion of the aperture uncovered by rolling the film member onto the rotating member and wherein the rotating member has a major longitudinal axis arranged in a generally vertical orientation.

12. An air passage opening/closing device comprising:
a plate member including an aperture arranged across an air passage;
a film member disposed adjacent the plate member, the film member being configurable for selectively covering or uncovering at least an upper portion of the aperture, the film member having a first end fixed relative to the plate member;
a rotating member, a second end of the film member being secured to the rotating member whereby rotation of the rotating member in a first direction will roll a portion of the film member onto the rotating member and rotation of the rotating member in a second and opposite direction will unroll a portion of the film member from the rotating member; and
an activating mechanism operatively connected to the rotating member for controlling the rotation of the rotating member, wherein the rotating member remains substantially above the first end of the film member.

13. An air passage opening/closing device according to claim 12, further comprising:
a fixing member for securing the first end of the film member to the plate member.

14. An air passage opening/closing device according to claim 12, wherein:
the plate member has an orientation that is inclined from vertical by an inclination angle of no more than about 30°.

15. An air passage opening/closing device according to claim 14, wherein:
the plate member has an orientation wherein an upper portion of the plate member is located upstream relative to a lower portion of the plate member.

16. An air-conditioning unit comprising:
a housing defining an air passage, the air passage defining at least a hot air path and a bypass path;
a cooling heat exchanger arranged in the air passage for selectively cooling air passing therethrough;
a heating heat exchanger arranged in the hot air path for selectively heating air passing therethrough and disposed in a downstream direction from the cooling heat exchanger, wherein the bypass path, when selectively activated, allows at least a portion of the air to bypass the heating heat exchanger;
an air-mixing device for adjusting an air-flow ratio between a first volume of air passing through the bypass path and a second volume of air passing through the hot air path;
an air-mixing chamber wherein air flowing through the bypass path and air flowing through the hot air path are combined to form a mixed air stream;
an air outlet provided in the housing in a downstream location from the air-mixing chamber through which the mixed air stream exits the housing; and
a first air passage flow control device configured to control flow through at least one of the hot air path and the bypass path, the first air passage flow control device including:
a first plate member including a first aperture;
a first film member disposed adjacent the first plate member, the first film member being configurable for selectively covering and uncovering at least an upper portion of the first aperture; and
a first rotating member disposed adjacent the first plate member and configured for movement between first and second positions along the first plate member, whereby a portion of the first film member is rolled onto the first rotating member during movement in a first direction and unrolled from the rotating member during movement in a second and opposite direction, the first rotating member being located substantially below any portion of the first aperture uncovered by rolling the film member onto the rotating member.

17. An air-conditioning unit according to claim 16, further comprising:
a second air passage flow control device arranged across at least one of the hot air path and the bypass path, the second air passage flow control device including:
a second plate member including a second aperture;
a second film member disposed adjacent the second plate member, the second film member being configurable for selectively covering and uncovering at least an upper portion of the second aperture; and
a second rotating member disposed adjacent the second plate member and configured for movement between first and second positions along the second plate member, whereby a portion of the second film member is rolled onto the second rotating member during movement in a first direction and unrolled from the rotating member during movement in a second and opposite direction, the second rotating member being located substantially below any portion of the second aperture uncovered by rolling the second film member onto the second rotating member.

18. An air-conditioning unit according to claim 16, further comprising:
a first activating mechanism including:
a first positioning mechanism for selectively moving the first rotating member to any position between the first and second positions while maintaining a longitudinal axis of the rotating member in a substantially parallel orientation.

19. An air-conditioning unit according to claim 17, further comprising:
a first activating mechanism including:
a first positioning mechanism for selectively moving the first rotating member to any position between the first and second positions while maintaining a longitudinal axis of the rotating member in a substantially parallel orientation; and
a second activating mechanism including:
a second positioning mechanism for selectively moving the second rotating member to any position between the first and second positions while maintaining a second aligned orientation.

20. An air-conditioning unit according to claim 18, wherein:
the first activating mechanism includes:
a first rotating shaft, the first rotating shaft including a spiral groove,
the spiral groove configured for receiving a first following member,
the first following member being attached to the first rotating member whereby rotation of the first rotating shaft will alter the position of the first rotating member in the first or second direction.

21. An air-conditioning unit according to claim 19, wherein:
the first activating mechanism includes:
a first rotating shaft, the first rotating shaft including a spiral groove,
the spiral groove configured for receiving a first following member,
the first following member being attached to the first rotating member whereby rotation of the first rotating shaft will alter the position of the first rotating member in the first or second direction, and
the second activating mechanism includes:
a second rotating shaft, the second rotating shaft including a spiral groove,
the spiral groove configured for receiving a second following member, the second following member being attached to the second rotating member whereby rotation of the second rotating shaft will alter the position of the second rotating member in the first or second direction.
